(19) United States
(12) Patent Application Publication
(10) Pub. No.: US 2019/0120680 A1
(43) Pub. Date: Apr. 25, 2019

(54) LEAK SENSOR

(71) Applicants: ZF FRIEDRICHSHAFEN AG, Friedrichshafen (DE); ZF WIND POWER ANTWERPEN N.V., Lommel (BE)

(72) Inventors: Johannes SCHAEFER, Friedrichshafen (DE); Georg TENCKHOFF, Friedrichshafen (DE); Kris SMOLDERS, Turnhout (BE); Luk GEENS, Lint (BE); Rik BEQUE, Wingene (BE)

(21) Appl. No.: 16/302,686

(22) PCT Filed: May 2, 2017
(86) PCT No.: PCT/EP2017/060343

§ 371 Date: Nov. 19, 2018

(30) Foreign Application Priority Data
May 20, 2016 (DE) 10 2016 208 764.9

(51) Int. Cl. G01F 23/26; G01M 3/40

(52) U.S. Cl. CPC G01F 23/268; G01F 23/266; G01M 3/40

(57) ABSTRACT

An arrangement includes a shaft, a case, and a capacitor having a first electrode and a second electrode. A gap is formed between the first electrode and the second electrode. The shaft extends through an opening in the case. The capacitor is arranged such that lubricant leaking out of the case through the opening at least partially enters the gap.

### CROSS REFERENCE TO RELATED APPLICATIONS

This application is a U.S. National Stage Application under 35 U.S.C. § 371 of International Application No. PCT/EP2017/060343 filed on May 2, 2017, and claims benefit to German Patent Application No. DE 10 2016 208 764.9 filed on May 20, 2016. The International Application was published in German on Nov. 23, 2017, as WO 2017/198445 A1 under PCT Article 21(2).

### FIELD

The invention relates to capacitive oil-level sensors.

### BACKGROUND

Capacitive oil-level sensors are known from the prior art. Said sensors use a capacitor in order to detect the presence of oil. If the oil penetrates a gap between the electrodes of the capacitor, the dielectric constant of said capacitor changes. A sensor of this kind makes it possible to determine whether the oil level in an oil sump exceeds or falls below a specific threshold value.

### SUMMARY

In an embodiment, the present invention provides an arrangement. The arrangement includes a shaft, a case, and a capacitor having a first electrode and a second electrode. A gap is formed between the first electrode and the second electrode. The shaft extends through an opening in the case. The capacitor is arranged such that lubricant leaking out of the case through the opening at least partially enters the gap.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a circuit arrangement according to an embodiment of the invention; and

FIG. 2 shows a leak sensor according to an embodiment of the invention.

### DETAILED DESCRIPTION

The capacitive oil sensors known from the prior art are not suitable for detecting oil leaks. In particular, feeding a shaft through a transmission case is subject to the risk of such a leak. In order to prevent leaked oil from causing environmental damage or an oil level that is too low leading to a transmission defect, leaks of this kind have to be detected in a prompt and reliable manner.

According to embodiments of the invention, arrangements are provided that include at least one shaft, at least one case, and at least one capacitor. The arrangement is preferably part of a transmission, such as a transmission of a wind turbine.

The shaft extends through an opening in the case. This means that a first part of the shaft is located outside the case, and a second part of the shaft is located inside the case. The shaft can thus be a drive shaft or an output shaft for instance. The opening is formed as a through-hole.

A first electrode and a second electrode of the capacitor form a gap. The gap thus extends between the first electrode and the second electrode. The gap is preferably filled with air.

According to embodiments of the invention, the capacitor is arranged such that a lubricant leaking out of the case through the opening at least partially enters the gap. If the gap is a gap filled with air, at least some of the air is displaced by the lubricant in the process.

A dielectric constant of the capacitor changes on account of the lubricant. A change of this kind is indicative of leaked lubricant. Accordingly, the arrangement preferably has an analysis unit which is designed to determine the dielectric constant of the capacitor and to detect a change in the dielectric constant.

By arranging, in a preferred configuration, the first electrode and/or the second electrode such that the first electrode and/or the second electrode form at least part of a border of the opening, the leaking lubricant can at least partially enter the gap. The border is a part of a surface of the case that surrounds the opening. Said surface part connects an interior or inner chamber to an exterior or surroundings of the case. The opening has two mouths. The two mouths each form an edge of said surface part.

In a further preferred configuration, the capacitor is arranged such that not only does leaking lubricant at least partially enter the gap, but also, conversely, lubricant does not enter the gap if the lubricant does not leak out of the case through the opening. This means that lubricant at least partially enters the gap if and only if the lubricant leaks out of the gap. Consequently, the change in the dielectric constant of the capacitor is a clear indication of a lubricant leak.

The capacitor is preferably arranged outside the case. This ensures that lubricant that does not leak out of the case through the opening does not enter the gap.

A seal is preferably provided which seals the case off with respect to the shaft along the opening. If the seal fulfils its purpose, lubricant cannot leak out of the case through the opening. The gap of the capacitor thus remains free of lubricant. Lubricant then at least partially enters the gap only when the seal fails.

In a further preferred configuration, the first electrode and/or the second electrode are rotationally symmetric with respect to an axis of symmetry that is identical to an axis of rotation of the shaft. In this way, a situation whereby the lubricant leaking out of the case through the opening flows past the gap and thus cannot be detected is reliably prevented.

The first electrode can be mounted on the case and the second electrode can be mounted on the shaft. In particular, the shaft can form the second electrode or can be integrally joined to at least part of the second electrode. If the first electrode is mounted on the case and the second electrode is mounted on the shaft, all lubricant leaking out of the case through the opening has to flow through the gap between the first electrode and the second electrode.

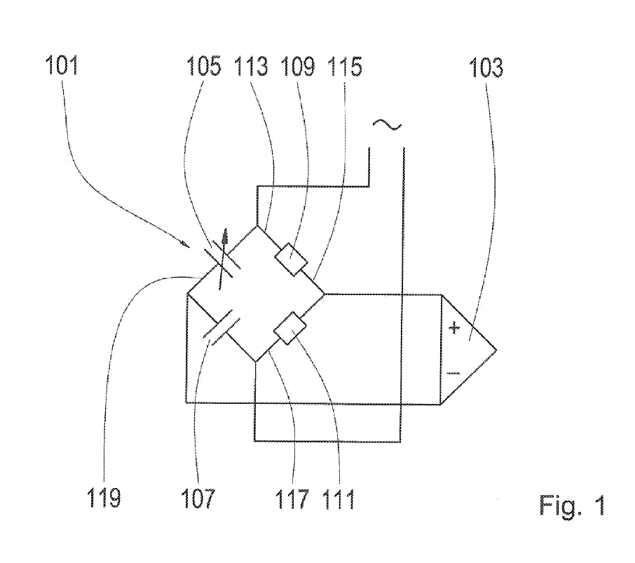

The circuit arrangement shown in FIG. 1 comprises a Wheatstone bridge 101 and an operational amplifier 103. The Wheatstone bridge 101 in turn has a first capacitor 105, a second capacitor 107, a first ohmic resistor 109 and a second ohmic resistor 111.

A first pole of the first capacitor 105 and a first terminal of the first ohmic resistor 109 are interconnected via a first electrical connection 113. Likewise, a second terminal of the first ohmic resistor 109 and a first terminal of the second ohmic resistor 111 are connected via a second electrically conductive connection 115, a second terminal of the second ohmic resistor 111 and a first pole of the second capacitor 107 are connected via a third electrically conductive connection 117, and a second terminal of the second capacitor 107 and a second terminal of the first capacitor 115 are connected via a fourth electrically conductive connection 119.

An AC voltage that drops between the first electrically conductive connection 113 and the third electrically conductive connection 117 is applied to the Wheatstone bridge 101. The operational amplifier 113 taps a voltage dropping between the second electrically conductive connection 115 and the fourth electrically conductive connection 119.

The first capacitor 105 is arranged such that a gap between the first pole and the second pole thereof is filled with oil in the event of a fault. The dielectric constant of said capacitor is changed as a result. This can be established at an output of the operational amplifier 103 by means of an analysis unit.

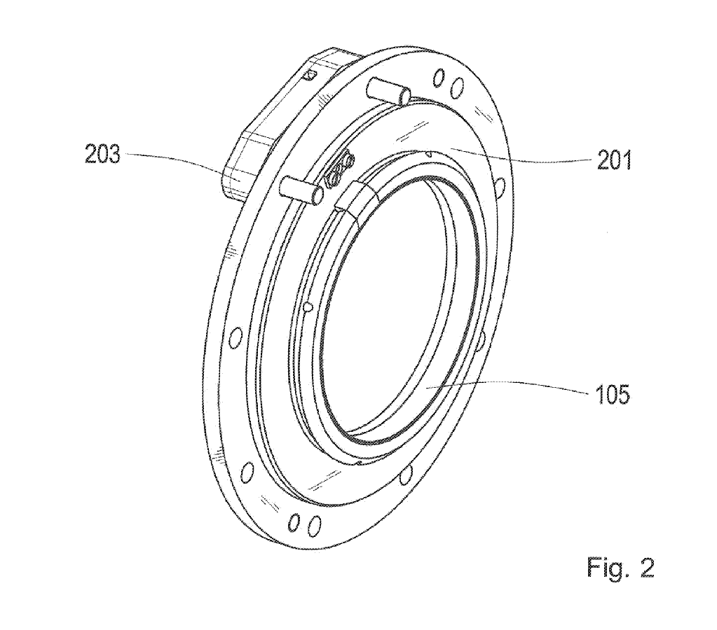

FIG. 2 shows a design of the first capacitor 105 by way of example. Accordingly, the first capacitor 105 is in the form of a lateral surface of a right circular cylinder. The first capacitor 105 can be fastened in a transmission case by means of a cover 201. In addition to the first capacitor 105, an analysis unit 203 comprising the Wheatstone bridge shown in FIG. 1 is also mounted on the cover 201.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

101 wheatstone bridge
103 operational amplifier
105 first capacitor
107 second capacitor
109 first ohmic resistor
111 second ohmic resistor
113 first electrically conductive connection
115 second electrically conductive connection
117 third electrically conductive connection
119 fourth electrically conductive connection
201 cover
203 analysis unit

1. An arrangement, comprising:
a shaft;
a case; and
a capacitor having a first electrode and a second electrode, a gap being formed between the first electrode and the second electrode;
wherein the shaft extends through an opening in the case; and
wherein the capacitor is arranged such that lubricant leaking out of the case through the opening at least partially enters the gap.

2. The arrangement according to claim 1; wherein the first electrode and/or the second electrode form at least part of a border of the opening in the case.

3. The arrangement according to claim 1, wherein the capacitor is arranged such that lubricant does not enter the gap if the lubricant does not leak out of the case through the opening.

4. The arrangement according to claim 1, wherein the first electrode and/or the second electrode are rotationally symmetric with respect to an axis of symmetry that is identical to an axis of rotation of the shaft.

5. The arrangement according to claim 1, wherein the first electrode is mounted on the case and the second electrode is mounted on the shaft.
